(19) United States
(12) Patent Application Publication
(10) Pub. No.: US 2005/0264951 A1
(43) Pub. Date: Dec. 1, 2005

(54) Dual CPP GMR with synthetic free layer

(75) Inventor: Hardayal Singh Gill, Palo Alto, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 10/857,125

(22) Filed: May 28, 2004

(51) Int. Cl. G11B 5/33; G11B 5/127

(52) U.S. Cl. 360/324.11

(57) ABSTRACT

A dual CPP GMR read head having a first pinned layer structure that is self pinned, and a second pinned layer structure that is AFM pinned. A synthetic free layer is sandwiched between the first and second pinned layer structures.

### FIELD OF THE INVENTION

The present invention relates to a current perpendicular to plane (CPP) giant magnetoresistive (GMR) sensor and more particularly to a Dual CPP GMR having a self-pinned pinned layer structure and an AFM pinned pinning structure and a synthetic free layer sandwiched therebetween.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of a rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

A spin valve sensor is characterized by a magnetoresistive (MR) coefficient that is substantially higher than the MR coefficient of an anisotropic magnetoresistive (AMR) sensor. For this reason a spin valve sensor is sometimes referred to as a giant magnetoresistive (GMR) sensor. When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. A spin valve is also known as a top or bottom spin valve depending upon whether the pinning layer is at the top (formed after the free layer) or at the bottom (before the free layer).

The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Sensors can also be categorized as current in plane (CIP) sensors or as current perpendicular to plane (CPP) sensors. In a CIP sensor, current flows from one side of the sensor to the other side parallel to the planes of the materials making up the sensor. Conversely, in a CPP sensor the sense current flows from the top of the sensor to the bottom of the sensor perpendicular to the plane of the layers of material making up the sensor. In a CPP sensor design, the magnetic shields usually double as electrical leads for supplying a sense current to the sensor. Therefore, in CPP sensor design, the shields/leads contact the top and bottom of the sensor, and the space between the shields defines the length of a bit of data.

The ever increasing demand for data storage density and data rate have increasingly pushed the limits of data storage designs. Recently in efforts to overcome such limits, engineers and scientists have focused on the use of perpendicular recording. In a perpendicular recording system a write pole emits a highly concentrated magnetic field that is directed perpendicular to the surface of the medium (eg. the disk). This field in turn magnetizes a localized portion of the disk in a direction perpendicular to the surface of the disk, thereby creating a bit of data. The resulting flux travels through the disk to a return path having a much larger area than the area in which the bit was recorded. The increased interest in perpendicular recording has lead to an increased interest in current perpendicular to plane (CPP) sensors, which are particularly suited to use in perpendicular recording.

The ever increasing demands for increase data density and data rate have also lead engineers to look at the possibility of constructing dual GMR sensors. Such a sensor would have two free layer/pinned layer interfaces, such as by having a free layer sandwiched between two pinned layers. However, many challenges presented by the use of such a design have prevented dual GMR sensors from being used, and to date no commercial dual GMR sensor has been produced. One problem presented by such a design is that the use of a dual GMR sensor takes up too much gap budget (the thickness of the sensor as measured from one shield to the other). Increased sensor thickness leads to increased bit length, and therefore leads to decreased data density and data rate. A significant contributor to this sensor gap increase has been due to the fact that each pinned layer requires its own antiferromagnetic AFM pinning layer. AFM layers used to pin the magnetic moment of a pinned layer through exchange coupling are very thick, often being significantly thicker than all of the other sensor layers combined. Therefore, the use of two AMF layers becomes impractical.

Another problem associated with the use of such dual GMR sensors has been achieving the proper magnetic alignment of the free and pinned layers, and the setting of the magnetic moments of such layers in such a way that the GMR effects across each of the spacer layers are additive rather than subtractive.

Therefore, there remains a need for a sensor that can provide improved dr/R GMR performance without sacrificing gap budget. Such a sensor would preferably be usable as a current perpendicular to plane sensor, since these are the sensor that will be most attractive for use in future perpendicular recording systems. Such a sensor would also preferably provide convenient setting of magnetic moments of the various layers, using currently available manufacturing methods.

### SUMMARY OF THE INVENTION

The present invention provides a current perpendicular to plane giant magnetoresistive sensor (GMR) that has a synthetic free layer sandwiched between first and second pinned layer structures. The first pinned layer structure is an antiparallel self pinned structure, that is pinned by magnetic anisotropy of the layers and without assistance of an AFM layer. The second pinned layer is an antiparallel coupled pinned layer structure that is pinned by exchange coupling of one of its magnetic layers with a layer of antiferromagnetic material. The first and second pinned layer structures are separated from the synthetic free layer structure by first and second non-magnetic, electrically conductive spacer layers respectively.

The first pinned layer can be constructed with first and second magnetic layers separated by a first non-magnetic coupling layer. The first and second magnetic layers are each constructed of a material having a positive magnetostriction and can be constructed or for example CoFe. The first magnetic layer can be constructed of CoFe having a 5 to 15 atomic percent or about 10 atomic percent Fe, and can be 25 to 35 Angrstroms thick or about 30 \acute{Å} thick. The second magnetic layer can be constructed of CoFe having 45 to 55 atomic percent Fe or about 50 atomic percent Fe and can be 25 to 35 \acute{Å} thick or about 30 \acute{Å} thick.

The second pinned layer structure includes third and fourth magnetic layers, which are separated by a second non-magnetic, electrically conductive coupling layer such as for example Ru. The second pinned layer structure has a magnetic moment that is pinned by exchange coupling one of the magnetic layers (such as the fourth magnetic layer) with a layer of antiferromagnetic material (AFM). The AFM can be for example IrMnCr. The third magnetic layer, which can be the layer closest to the second spacer layer, can be constructed of CoFe having 45 to 55 or about 50 atomic percent Fe, and can have a thickness of 25 to 35 or about 30 \acute{Å}. The fourth magnetic layer can be constructed of CoFe having 25 to 35 atomic percent or about 30 atomic percent Fe, and can be 25 to 35 or about 30 \acute{Å} thick.

The synthetic free layer includes fifth and sixth magnetic layers separated by a third non-magnetic, electrically conductive coupling layer. The fifth and sixth magnetic layers could be constructed of Co/Fe with about 5 to 15 or about 10 atomic percent Fe, and could also be multilayer structures including one or more layers of CoFe and one or more layers of NiFe. The fifth and sixth magnetic layers are antiparallel coupled across the third coupling layer, but they have magnetic thicknesses that are unequal to one another. This ensures that that free layer has a net magnetic moment to allow the free layer to responds to the presence of a magnetic field by changing the direction of its magnetization accordingly.

The use of the synthetic free layer advantageously increases dr/R while also providing a free layer that is soft enough to respond effectively to the presence of a magnetic field. In a CPP GMR sensor, increased free layer thickness advantageously increases dr/R by increasing spin dependent electron scattering. However, in a simple free layer, the increased free layer thickness reduces sensor sensitivity to the point that the free layer becomes insensitive to magnetic fields, and the magnetic moment of the free layer will not rotate as needed. By using a synthetic free layer having two antiparallel coupled ferromagnetic layers having unequal magnetic thicknesses, the advantages of increases free layer thickness can be employed while still maintaining desirable free layer softness.

In addition, the use of a self pinned pinned layer structure advantageously, minimizes sensor thickness by eliminating one of the AFM layers. Since AFM layers used to pin pinned layer structures must be made very thick relative to the other layers, the elimination of one of the AFM layers greatly reduces the sensor thickness, thereby decreasing bit length. These and other advantages of the present invention will be better appreciated upon reading of the following detailed description of the preferred embodiments.

### BRIEF DESCRIPTION OF THE DRAWINGS

For a fuller understanding of the nature and advantages of this invention, as well as the preferred mode of use, reference should be made to the following detailed description read in conjunction with the accompanying drawings.

FIG. 1 is a schematic illustration of a disk drive system in which the invention might be embodied;

FIG. 2 is an ABS view of a slider illustrating the location of a magnetic head thereon;

FIG. 3 is an ABS view of a magnetic sensor according to an embodiment of the present invention taken from circle 3 of FIG. 2, shown enlarged and rotated 90 degrees counterclockwise; and

FIG. 4 is a cross sectional view taken from line 4-4 of FIG. 3.

### BEST MODE FOR CARRYING OUT THE INVENTION

The following description is of the best embodiments presently contemplated for carrying out this invention. This description is made for the purpose of illustrating the general principles of this invention and is not meant to limit the inventive concepts claimed herein.

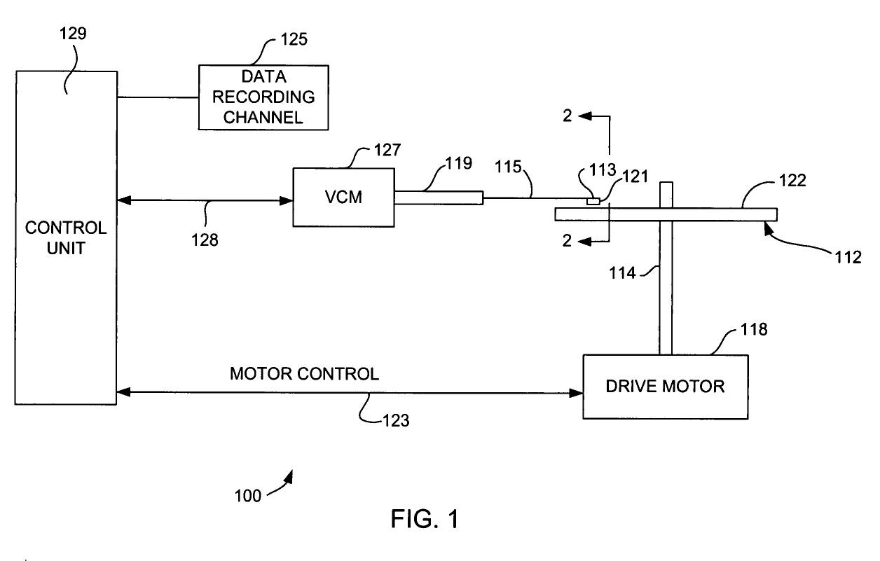

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

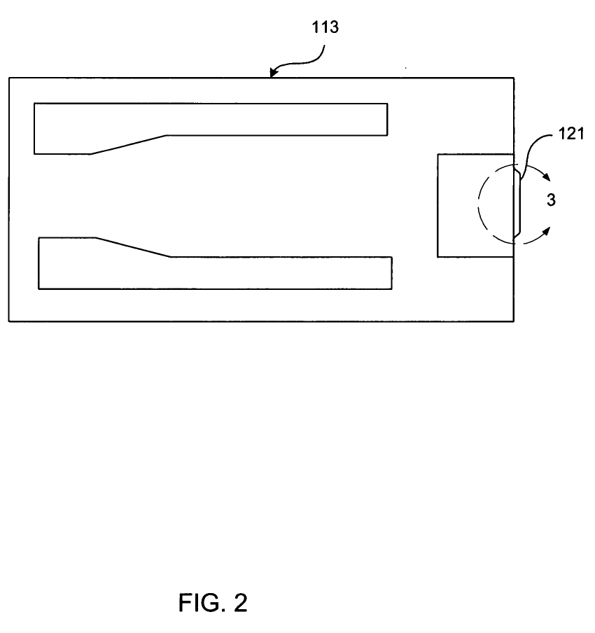

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

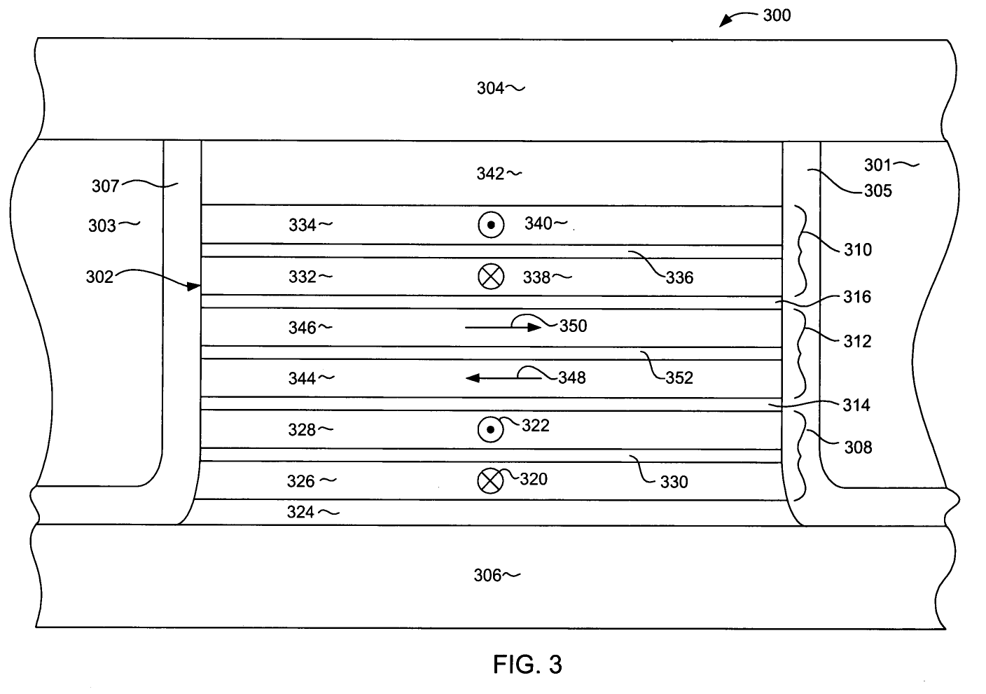

With reference now to FIG. 3, a current in plans magnetoresistive sensor 300 includes a sensor stack 302 sandwiched between first and second magnetic shields 304, 306. The shields 304, 306 are constructed of a magnetic, electrically conductive material and function as both magnetic shields and as electrical leads for providing a sense current to the sensor 300. First and second hard bias layers 301, 303 extend laterally outward from the sensor stack 302 and are separated from the sensor stack 302 by first and second insulation layers 305, 307. The insulation layers 305, 307 prevent current shunting across the bias layers 301, 303.

The sensor stack 302 includes first and second pinned layer structures 308, 310 and a synthetic free layer structure 312. A first non-magnetic, electrically conductive spacer layer 314 separates the first pinned layer structure 308 from the free layer structure 312. Similarly, a second non-magnetic, electrically conductive spacer layer 316 separates the second pinned layer structure from the free layer structure. The spacer layers 314, 316 can be constructed of several non-magnetic, electrically conductive materials and are preferably constructed of Cu.

With continued reference to FIG. 3, the first pinned layer structure 308 is a self pinned structure. This means that the magnetizations 320, 322 off the first pinned layer structure 308 are pinned in a direction perpendicular to the ABS without the assistance of exchange coupling with an antiferromagnetic layer (AFM). Instead, pinning is maintained by a combination of positive magnetostriction of the pinned layer materials and compressive stresses in the sensor 300 or pinned using high Hc material in layer 326 (e.g. CoPtCr or FePt).

The first pinned layer structure 308 is constructed upon a seed layer 324, which is constructed of a material that promotes a desired epitaxial growth of the subsequently deposited sensor layers. In this light the seed layer can be constructed of for example, Ta(30 \acute{Å})/NiFeCr(30 \acute{Å})/NiFe(8 \acute{Å})/PtMn(30 \acute{Å}), IrMn or Ta(30 \acute{Å})/NiFeCr(30 \acute{Å}). The first pinned layer 302 includes first and second magnetic layers 326, 328, separated by a non-magnetic, electrically conductive first coupling layer 330. The first coupling layer can be constructed of, for example, Ru and is constructed to have a thickness that will antiparallel couple the magnetic moments 320, 322 of the first and second magnetic layers 328, 326. This thickness of the first coupling layer could be for example 4-8 \acute{Å}. The first and second magnetic layers 326, 328 can be constructed to have a thickness of 25-35 \acute{Å} each or about 30 \acute{Å} each.

As mentioned above, the first and second magnetic layers 326, 328 are constructed of a material having a positive magnetostriction which, in combination with compressive stresses in the sensor 300 provides a strong magnetic anisotropy that pins the magnetizations 320, 322 in a desired direction perpendicular to the ABS. To this end, the first magnetic layer 326 can be constructed of CoFe having 5 to 15 atomic percent Fe, or about 10 atomic percent Fe. Similarly, the second magnetic layer 328 can be constructed of CoFe having 45 to 55 atomic percent Fe or about 50 atomic percent Fe. Constructing the first and second magnetic layers 326, 328 of different materials as described above results in first and second layers 326, 328 having different magnetic anisotropies. This will be useful in the setting of the magnetic moments, which will be discussed further herein below.

The second pinned layer structure 310 includes third and fourth magnetic layers 332, 334 separated by a second non-magnetic, electrically conductive coupling layer 336. The second pinned layer structure 310 is an AFM pinned structure, in that it has magnetic moments 338, 340 that are pinned by exchange coupling of the fourth magnetic layer 334 with a layer of antiferromagnetic material (AFM) 342. The AFM layer 342 can be constructed of many antiferromagnetic materials, but is preferably constructed of IrMnCr, which can be for example 50-90 \acute{Å} thick. Those skilled in the art will recognize that other AFM material that have been used for AFM pinning, such as PtMn, have by necessity been much thicker, such as greater than 100 \acute{Å}. Therefore, significant sensor thickness reduction can be realized by the use of IrMnCr.

With continued reference to FIG. 3, the second coupling layer 336, which can be for example Ru, is constructed of a thickness that will antiparallel couple the magnetic moments 338, 340 of the third and fourth magnetic layers 332, 334. The second coupling layer could be for example 4-8 \acute{Å}. The third and fourth magnetic layers 332, 334 can each have a thickness, for example, of 25 to 35 \acute{Å} or 30 \acute{Å}. The third magnetic layer 332 can be constructed of CoFe having 45 to 55 atomic percent or about 50 atomic percent Fe. The fourth magnetic layer can be constructed of CoFe having a 25 to 35 atomic percent or about 30 atomic percent Fe. As with the first pinned layer structure, the third and fourth magnetic layers 332, 334 of the second pinned layer structure 310 have different magnetic anisotropies, which aids in setting the pinned layers. Also, about 30% Fe in CoFe provides stronger exchange coupling to IrMnCr.

With reference still to FIG. 3, the free layer structure 312 includes fifth and sixth magnetic layers 344, 346 that have magnetic moments 348, 350 that are antiparallel coupled across a third non-magnetic, electrically conductive coupling layer 352. Like the other coupling layers, the third coupling layer can be constructed of Ru or some other suitable material, and is constructed of a thickness to antiparallel couple the magnetic moments 348, 350 of the fifth and sixth magnetic layers 348, 350. The third coupling layer can be 4-8 \acute{Å}.

The fifth and sixth magnetic layers are constructed to have different magnetic thicknesses so that the free layer 312 as a whole will have a magnetic moment that will allow it to respond to the presence of a magnetic field. Magnetic thickness can be defined as the magnetic moment of a material multiplied by it's thickness. In the case of the presently described embodiment, the fifth and sixth magnetic layers 348, 350 can be constructed of the same material or materials, but can be constructed to have different physical thicknesses. For example, the fifth magnetic layer 348 can have a thickness of 55-65 \acute{Å} or about 60 \acute{Å}. The sixth magnetic layer can be constructed to have a thickness of 85-95 \acute{Å} or about 90 \acute{Å}. The fifth and sixth magnetic layers 348, 350 could each be constructed as multilayer structures having one or more layers of CoFe and one or more layers of NiFe. The CoFe layer could have 5-15 atomic percent Fe or about 10 atomic percent Fe and preferably a layer of CoFe would be located adjacent to each of the spacer layers 314, 316. Alternatively, the fifth and sixth magnetic layers 348, 350 could be constructed of only CoFe, such as CoFe₁₀. GMR performance (dr/R) in a CPP GMR improves with increased free layer thickness. However, increasing free layer thickness in a simple free layer also increases the magnetic hardness of the free layer, resulting in a free layer that will not properly respond to a magnetic signal. Making the free layer as an AP coupled structure as described above advantageously provides the advantages of increased free layer thickness, while effectively giving the free layer a magnetic softness that is equivalent to the difference between the thicknesses of the fifth and sixth magnetic layers 344, 346.

Setting the pinned and free layer magnetizations is especially important and challenging in a dual spin valve having a synthetic free layer. As those skilled in the art will appreciate, in the design described above, the magnetic moments of the second and third magnetic layers 328, 332 (the pinned layers closest to the spacer layers 314, 316) must be antiparallel to one another. This is so that the GMR effect of each magnetic layer 328, 332 with regard to its respective free layer magnetic layer 344, 346 will be additive rather than subtractive. For example, if the magnetic moment of the second pinned magnetic layer 328 is directed out of the page as indicate by arrow-head symbol 322, and the third magnetic layer moment is directed into the page as indicated by arrow-tail symbol 338, then if the moments of the free layer 312 are directed as indicated by arrows 348, 350 the resultant GMR effects will be additive when the free layer responds to a magnetic field.

To set the magnetic moments 340, 338 of the second pinned layer structure 310, the sensor 300 is heated to a temperature equal to or greater than the blocking temperature of the AFM layer 342. At this temperature the AFM layer 342 ceases to be antiferromagnetic. Those skilled in the art may recognize that, since the third and fourth magnetic layers 332, 334 have are constructed of different material compositions, the will have different magnetic anisotropies. As the temperature is lowered below the blocking temperature of the AFM, the layer next to AFM (in this case the fourth magnetic layer 334) will be magnetized in the direction of the applied field, while magnetization of the layer 332 will attain orientation 180 degrees opposite to that of the layer 334. With the sensor cooled below it's the blocking temperature of the AFM layer 342 the fourth magnetic layer 334 will be exchange coupled with the AFM layer 342 and the pinned layer structure 310 will be strongly pinned.

In a somewhat similar manner, to set the magnetization of the first pinned layer structure 308, a strong magnetic field is applied in a direction of the desired magnetic moment 322 of the second magnetic layer. There will be no need to heat the sensor 300 when setting the moments of the first pinned layer 308, because the first pinned layer has no AFM layer. The magnetic field applied to set the first pinned layer 308 is sufficiently strong to saturate the moments of both the first and second magnetic layers 326, 328. One of the first and second magnetic layers (in this case the second magnetic layer 328) has a stronger magnetic anisotropy due to its different material composition. As the magnetic field is reduced, the moment of the layer having the stronger anisotropy in this case the second magnetic layer 328 will remain in direction of the magnetic field, while the other magnetic layer (in this case the first magnetic layer 326) will flip directions to be antiparallel with the other layer 328.

With regard to the first pinned layer structure 308, the layer having the stronger anisotropy 328 can be referred to as the master, because it determines the direction of moment, while the other layer 326 can be referred to as the slave, since its orientation is determined by the orientation of the master 328. Similarly, the fourth magnetic layer 334 can be referred to as the master, while the third magnetic layer 332 can be referred to as the slave.

The magnetic moment bias direction of the free layer 312 is determined by the thicker of the two magnetic layers, fifth layer 344 and sixth layer 346. Biasing is provided by magnetostatic coupling with the first and second hard bias layers 301, 303 which can be set by application of a magnetic field that does not have to be as strong as the magnetic field used to set the pinned layers. In fact the magnetic field used to set the bias layers 301, 303 should be weak enough not to undo the setting of the first and second pinned layers 308, 310.

The strong exchange coupling of the fourth magnetic layer 334 with the AFM layer 342 will cause the second pinned layer structure 310 to maintain its previously set moment after the magnetic field used to set the first pinned structure 308 has been removed. This is true even if the magnetic field used to set the first magnetic layer saturates both layers 332, 334 of the second pinned structure

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A current perpendicular to plane (CPP) giant magnetoresistive (GMR) sensor, comprising
a first pinned layer structure, comprising:
first and second magnetic layers separated by a first non-magnetic, electrically conductive coupling layers;
the first pinned layer having a magnetic moment that is self-pinned without the assistance of an exchange coupled antiferromagnetic (AFM) layer;
a second pinned layer structure, comprising
third and fourth magnetic layers separated by a non-magnetic, electically conductive antiparallel coupling layer;
the second pinned layer structure having a magnetic moment that is pinned by exchange coupling of one of the third and forth magnetic layers with a layer of antiferromagnetic material (AFM);
a synthetic free layer structure, discposed between the first and second pinned layer structures; the synthetic free layer structure comprising;
a fifth and sixth magnetic layers separated by a third non-magnetic antiparallel coupling layer;
a first non-magnetic, electrically conductive spacer layer disposed between the first pinned layer structure and the synthetic free layer structure; and
a second non-magnetic, electrically conductive spacer layer disposed between the second pinned layer structure and the synthetic free layer structure.

2. A sensor as in claim 1, wherein said first and second magnetic layers are have a magnetic thicknesses that are substantially equal to one another.

3. A sensor as in claim 1, wherein said first and second magnetic layers are constructed of a material having a positive magnetostriction.

4. A sensor as in claim 1, wherein:
the sensor has an air bearing surface;
the first and second magnetic layers each have a magnetic anisotropy perpendicular to the ABS; and
the magnetic anisotropies of the first and second magnetic layers are unequal to one another.

5. A sensor as in claim 1, wherein the first magnetic layer comprises CoFe having about 10 atomic percent Fe, and the second magnetic layer comprises CoFe having about 50 atomic percent Fe.

6. A sensor as in claim 1, wherein the second magnetic layer is disposed closer to the free layer structure than the first magnetic layer is.

7. A sensor as in claim 1, wherein the third magnetic layer comprises CoFe having about 50 atomic percent Fe, and the fourth magnetic layer comprises CoFe having about 30 atomic percent Fe.

8. A sensor as in claim 1, wherein the first magnetic layer comprises CoFe having 5 to 15 atomic percent Fe and wherein the second magnetic layer comprises CoFe having 45 to 55 atomic percent Fe.

9. A sensor as in claim 1, wherein the third magnetic layer comprises CoFe having 45 to 50 atomic percent Fe, and wherein the fourth magnetic layer comprises 35 to 35 atomic percent Fe.

10. A sensor as in claim 1, wherein the first and second magnetic layers each have a thickness of about 30 \acute{Å}.

11. A sensor as in claim 1, wherein the first and second magnetic layers each have a thickness of 25 to 35 \acute{Å}.

12. A sensor as in claim 1, wherein the third and fourth magnetic layers each have a thickness of about 30 \acute{Å}.

13. A sensor as in claim 1, wherein the third and fourth magnetic layers each have a thickness of 25 to 35 \acute{Å}.

14. A sensor as in claim 1, wherein the fifth and sixth magnetic layers comprise CoFe having about 10 atomic percent Fe.

15. A sensor as in claim 1, wherein the fifth and sixth magnetic layers comprise CoFe having 5 to 15 atomic percent Fe.

16. A sensor as in claim 1, wherein at least one of the fifth and sixth magnetic layers comprises a multilayer structure including a layer of CoFe and a layer of NiFe.

17. A sensor as in claim 1, wherein the CoFe layer is distal from the third coupling layer.

18. A sensor as in claim 1, wherein the second magnetic layer is disposed adjacent to the first spacer layer and wherein the second magnetic layer has a greater magnetic anisotropy than the first magnetic layer.

19. A sensor as in claim 1, wherein the third magnetic layer is disposed adjacent to the second spacer layer and wherein the third magnetic layer has a greater magnetic anisotropy than the fourth magnetic layer.

20. A sensor as in claim 1, wherein:
the sensor has an air bearing surface;
the first second, third and fourth magnetic layers have magnetic moments that are pinned perpendicular to the ABS; and
the fifth and sixth magnetic layers have magnetic moments that are biased parallel with the ABS and perpendicular to the magnetic moments of the first, second, third and fourth magnetic layers.

21. A sensor as in claim 1, wherein the layer of AFM material comprises IrMnCr.

22. A sensor as in claim 1, wherein the layer of AFM material comprises a IrMnCr and has a thickness of 50 to 90 \acute{Å}.

21. A magnetic data recording system, comprising:
a magnetic medium;
a motor connected with the magnetic medium to move the magnetic medium;
an actuator;
a slider connected with the actuator for movement across a surface of the magnetic medium; and
a current perpendicular to plane (CPP) giant magnetoresistive (GMR) sensor connected with the slider, the sensor comprising:
a first pinned layer structure, comprising:
first and second magnetic layers separated by a first non-magnetic, electrically conductive coupling layers, the first pinned layer having a magnetic moment that is self-pinned without the assistance of an exchange coupled antiferromagnetic (AFM) layer;
a second pinned layer structure, comprising third and fourth magnetic layers separated by a non-magnetic, electically conductive antiparallel coupling layer, the second pinned layer structure having a magnetic moment that is pinned by exchange coupling of one of the third and forth magnetic layers with a layer of antiferromagnetic material (AFM);
a synthetic free layer structure, disposed between the first and second pinned layer structures; the synthetic free layer structure comprising, a fifth and a sixth magnetic layer separated by a third non-magnetic antiparallel coupling layer;
a first non-magnetic, electrically conductive spacer layer disposed between the first pinned layer structure and the synthetic free layer structure; and
a second non-magnetic, electrically conductive spacer layer disposed between the second pinned layer structure and the synthetic free layer structure.
